(19) United States
(12) Patent Application Publication
(10) Pub. No.: US 2025/0224577 A1
(43) Pub. Date: Jul. 10, 2025

(54) OPTICAL TRANSCEIVER MODULE AND METHODS OF MAKING AND USING THE SAME

(71) Applicant: Source Photonics (Chengdu) Co., Ltd., Chengdu (CN)

(72) Inventors: Libing ZHU, Chengdu (CN); Yi GAO, Chengdu (CN); Hongqi WU, Chengdu (CN)

(21) Appl. No.: 18/291,384

(22) PCT Filed: Oct. 11, 2023
(86) PCT No.: PCT/CN2023/124065

§ 371 Date: Jan. 23, 2024

(51) Int. Cl. G02B 6/42; H04B 10/40

(52) U.S. Cl. CPC G02B 6/4269; G02B 6/4246; H04B 10/40

(57) ABSTRACT

A heat sink for an optical or optoelectronic module, optical transceiver modules including the heat sink, and methods of making the heat sink and using the optical transceiver module are disclosed. The heat sink includes a shell body and a shell top. The shell body includes a metal or metal alloy, fins integral with the shell body and comprising the metal or metal alloy, and one or more airflow passages between adjacent fins. The shell top is in physical and/or thermal contact with the shell body and the fins, and includes the same or different metal or metal alloy. The shell top has opposing sidewalls including the same or different metal or metal alloy. The opposing sidewalls are configured to secure the shell top to the shell body. The fins are configured to transfer heat to (i) air in the airflow passage(s) and (ii) the shell top.

### FIELD OF THE INVENTION

The present invention relates to the field of optical communication, especially to optical and optoelectronic transceivers, heat sinks for the same, and methods of making and using the same.

### DISCUSSION OF THE BACKGROUND

In optical communications, optical signals carry information. For example, a transmitter (e.g., a laser or laser diode) in an optical or optoelectronic transceiver converts one or more electrical signals into optical signals, and a receiver (e.g., a photodiode) in an optical or optoelectronic transceiver converts one or more optical signals into electrical signals. One objective of optical communication research and development is to increase and/or maximize bandwidth (e.g., the amount of information transmitted per channel, per device, or per unit time) to the greatest extent possible.

Optoelectronic transceivers are often manufactured in the form of a module. Many optoelectronic transceiver modules have standardized forms. Some well-known standard module forms include small form factor (SFF), gigabit interface converter (GBIC), small form factor pluggable (SFP), quad small form factor pluggable (QSFP), octal small form factor pluggable (OSFP), and OSFP extra Dense (OSFP-XD).

In optoelectronic transceivers, the electrical signals can generate heat that can damage the device unless it is dissipated. Some optoelectronic transceiver modules have heat sinks on or in their packaging to help dissipate heat generated therein. Commercial interest in closed top packaging for SFP, QSFP and OSFP modules that may improve thermal conductivity and EMI is strong, although interest in open-top packaging also exists.

FIG. 1 shows an example of the electrical interface of an optical module 100 with closed-top packaging. The electrical interface includes a circuit board 120 with electrical contacts (e.g., “golden fingers”) 122 thereon, a base 130 with a circuit board cover 140, and a shell 150 with a heat sink 110 thereon. The heat sink 110 includes a plurality of fins 112 with spaces or airflow channels 114 between adjacent fins 112, and a break and/or sharp edge 116 at one or more ends of the heat sink 110. The heat sink 110 has a closed uppermost surface, and is therefore considered part of a “closed-top” package.

Such closed-top packaging is implemented primarily as (i) one of two main materials and (ii) one of two implementation methods for the airflow channels 114. FIG. 2A shows the electrical interface 200 of an optical module, including a shell 210, a base 220, a circuit board 230 and a host interface 240. FIG. 2B is a cross-section of the optical module 200 in FIG. 2A along the line A-A′. Within and/or on an inner surface of the shell 210 is a copper heat sink 215, welded into the shape shown in FIG. 2B and including a plurality of zipper fins 212, with spaces or airflow channels 214 between adjacent fins 212. A lowermost surface of the heat sink 215 may be integrally bonded or soldered to the shell 210. Alternatively, the heat sink 215 may comprise aluminum, extruded into the shape of the fins 212 shown in FIG. 2B, and then integrally bonded or soldered to the shell 210. On a lower/bottom horizontal surface of the base 220 may be an additional heat sink 250 with airflow channels 254 therein.

At present, closed-top optical module packaging requires the bonding of heat dissipation fins 212 to structural components of the optical module, primarily the shell 210. The thermal conductivity of typical adhesive materials, such as commonly-used solders (e.g., Sn₄₂Bi₅₈, which has a thermal conductivity of less than 30 w/m·k), is lower than that of the heat dissipation fins 212 and the module materials (usually compliant with one or more American Society for Testing and Materials [ASTM] standards), resulting in an increase in thermal resistance and relatively poor heat dissipation. Moreover, the adhesive can sometimes be applied or coated unevenly, further adversely affecting the heat dissipation capability of the heat sink 215 and sometimes causing detachment of the adhesive. At the same time, such adhesion processes may suffer from a low yield, and the implementation of different materials can also lead to increased costs.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention thus concerns a heat sink for an optical or optoelectronic module, an optical transceiver module that includes a closed-top package, and methods of making and using the same.

The present invention is intended to overcome one or more deficiencies in the prior art, and provide a heat sink for an optical or optoelectronic module, comprising a shell body and a shell top. The shell body comprises a first metal or metal alloy, a plurality of fins integral with the shell body and comprising the first metal or metal alloy, and one or more airflow passages between adjacent ones of the integral fins. The shell top is in physical and/or thermal contact with the shell body and the plurality of fins, and comprises a second metal or metal alloy and first and second opposing sidewalls comprising the second metal or metal alloy. The first and second opposing sidewalls are configured to secure the shell top to the shell body. The plurality of fins are configured to transfer heat to (i) air in the one or more airflow passages and (ii) the shell top. The first and second metals or metal alloys may be the same or different.

The fins are configured to dissipate heat generated in the optical or optoelectronic module (e.g., primarily by electrical components therein, such as integrated circuits, laser diodes, electrical wires or traces, etc.) and are part of and/or integral with the shell body. Thus, the metal or metal alloy in the shell body and the fins generally has an identical composition. The heat source(s) in the optical or optoelectronic module transfer or introduce heat into the shell body, and the shell body transfers heat to the shell top, using conventional thermally conductive interface materials. Air passing through the airflow passages and along the fins (in addition to air flowing along the external surface of the shell top) removes the heat from the optical or optoelectronic module.

In some embodiments, the present heat sink further comprises a plurality of fasteners configured to secure the shell top to the shell body. The plurality of fasteners may comprise a bolt or a screw. In such embodiments, one of the shell top and the shell body further comprises a corresponding plurality of pass-through holes having dimensions allowing the fasteners to pass therethrough, and the other of the shell top and the shell body further comprises a corresponding plurality of receiver holes configured to receive the fasteners. Alternatively or additionally, the present heat sink may further comprise a thermally conductive adhesive between the shell top and the shell body and/or in contact with both of the shell top and the shell body.

In various embodiments, each of the first metal or metal alloy and the second metal or metal alloy independently comprises zinc, a zinc alloy, copper, brass, bronze, aluminum, an aluminum alloy, iron, steel, titanium or nichrome.

The present heat sink may comprise 2-12 fins, for example. In such heat sinks, each of the airflow passages may have a cross-section that is rectangular, square, oval, rectangular or square with rounded corners, trapezoidal or trapezoidal with rounded corners. Alternatively or additionally, each of the plurality of fins may have a cross-section that is rectangular, rectangular with flared end (e.g., uppermost and/or lowermost) sections, trapezoidal or trapezoidal with flared end sections. In general, each of the fins may have a cross-sectional shape that is complementary to a cross-sectional shape of adjacent one(s) of the one or more airflow passages.

In various embodiments, the shell body further comprises (i) first and second shell body sidewalls on opposing sides of the shell body and (i) first and second tabs on the opposing sides of the shell body. The first and second shell body sidewalls may contact the opposing sidewalls of the shell top, and the tabs may be configured to contact or mate with sidewalls of a base of the optical module.

The present optical transceiver module may comprise a transmitter optical subassembly (TOSA), a receiver optical subassembly (ROSA), an electrical interface in communication with each of the TOSA and the ROSA, an optical interface in communication with each of the TOSA and the ROSA, a circuit board with at least one integrated circuit thereon, and the present heat sink. The integrated circuit(s) is/are in communication with at least one of the TOSA, the ROSA, the electrical interface and the optical interface. The heat sink is in thermal proximity or thermal communication with the integrated circuit(s). The present optical transceiver module may further comprise a handle adjacent to the optical interface.

In many embodiments, the integrated circuit(s) comprise a plurality of laser diodes, each configured to receive a driver signal and output a first optical signal; a plurality of optical modulators corresponding to the plurality of laser diodes, each of the optical modulators being configured to modulate a corresponding first optical signal; and/or a plurality of photodiodes, each configured to receive a second optical signal and output an electrical signal. The integrated circuit(s) may further comprise a plurality of laser drivers corresponding to the laser diodes, wherein each of the laser drivers may be configured to provide a corresponding driver signal to a corresponding one of the laser diodes; a bias control circuit, configured to provide one or more bias control signals to the laser diodes; and/or a plurality of amplifiers, each configured to amplify a unique electrical signal from the photodiodes. Alternatively or additionally, the integrated circuit(s) may further comprise a microprocessor or a microcontroller, configured to control the laser diodes, the optical modulators, the laser drivers, the bias control circuit, and/or the amplifiers.

The present invention also concerns a method of making a heat sink for an optical module, comprising forming a shell body, forming a shell top, and fastening the shell top to the shell body. As for the heat sink, the shell body comprises a first metal or metal alloy, a plurality of fins integral with the shell body and comprising the first metal or metal alloy, and one or more airflow passages between adjacent ones of the fins; and the shell top comprises a second metal or metal alloy and having first and second opposing sidewalls comprising the second metal or metal alloy. The first and second metals or metal alloys may be the same or different.

In some embodiments of the method, the shell top is fastened to the shell body with a plurality of fasteners. The fasteners may comprise a bolt or a screw, in which case one of the shell top and the shell body may further comprise a corresponding plurality of pass-through holes having dimensions allowing the plurality of fasteners to pass therethrough, and the other of the shell top and the shell body may further comprise a corresponding plurality of receiver holes configured to receive the plurality of fasteners. Alternatively or additionally, the shell top may be fastened to the shell body with a thermally conductive adhesive between and in contact with both of the shell top and the shell body.

The present invention still further concerns a method of operating an optical or optoelectronic transceiver module, comprising generating a plurality of first optical signals from a plurality of laser diodes in response to a plurality of driver signals, generating a plurality of electrical signals from a plurality of photodiodes in response to a plurality of second optical signals; and dissipating heat from the optical transceiver module using the present heat sink.

The present heat sink is able to transfer heat from various heat sources in the optical or optoelectronic module more effectively and/or more efficiently than previous designs. Furthermore, the present heat sink may be manufactured more efficiently and/or at a lower cost than previous designs. These and other advantages of the present invention will become readily apparent from the detailed description of various embodiments below.

### BRIEF DESCRIPTION OF THE DRAWINGS

FIG. 1 is a diagram showing an electrical interface of an exemplary optical transceiver having a closed-top packaging configuration.

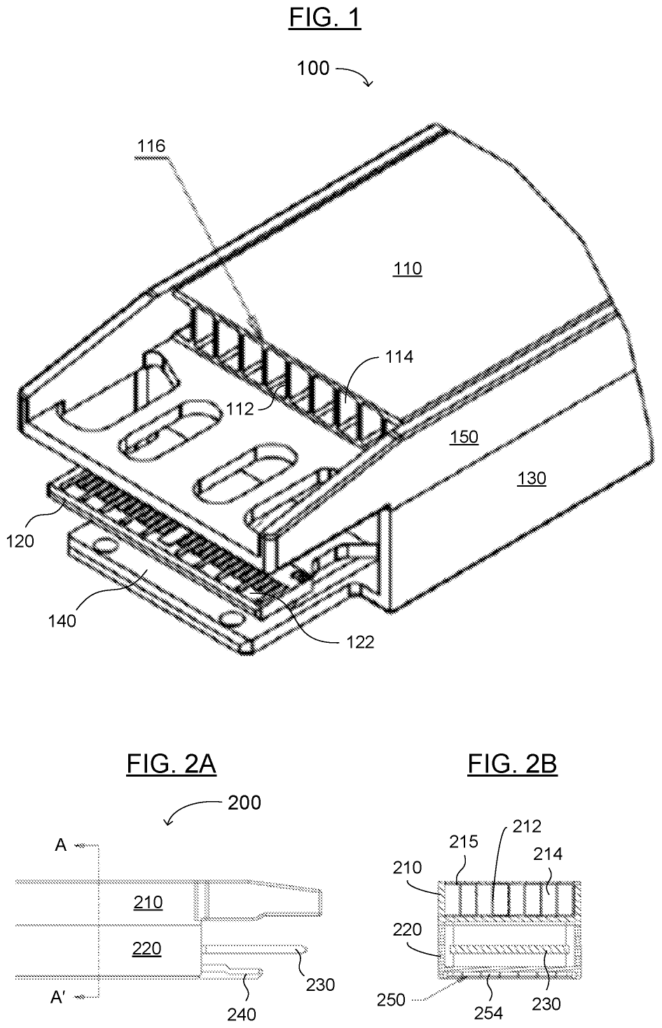

FIGS. 2A-B are diagrams showing different views of an electrical interface of an exemplary optical transceiver having a closed-top packaging configuration.

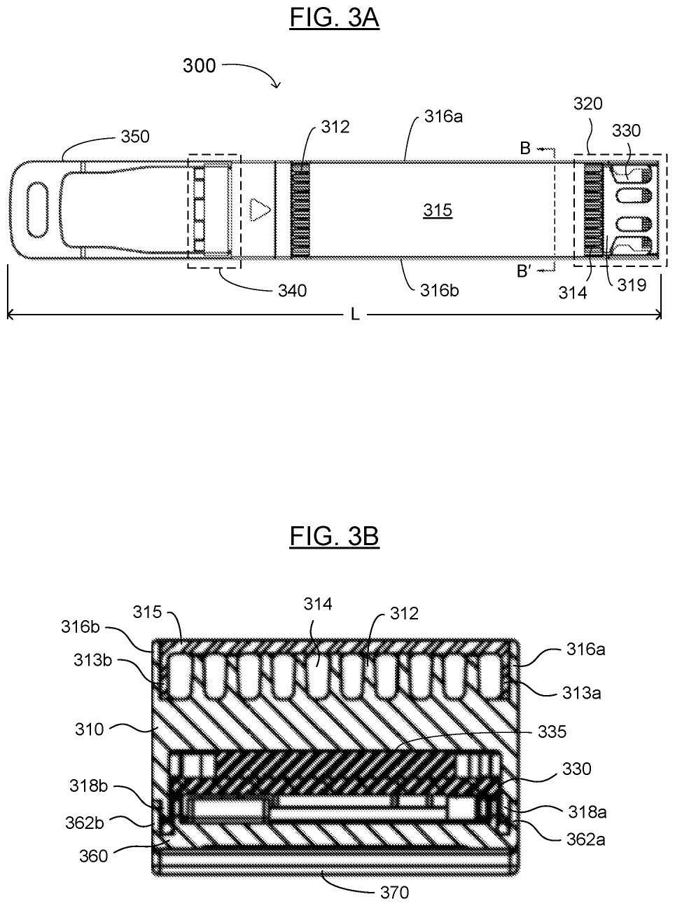

FIGS. 3A-B are diagrams showing top and end views of an electrical interface of an exemplary optical transceiver module having a closed-top packaging configuration, in accordance with the present invention.

FIG. 4 is a perspective view showing the exemplary optical transceiver of FIGS. 3A-B having a closed-top packaging configuration, in accordance with the present invention.

FIGS. 5A-B are diagrams showing exploded perspective views from the bottom and top of exemplary components of the heat sink in the exemplary optical transceiver of FIGS. 3A-B in accordance with one or more embodiments of the present invention.

FIG. 6 is a diagram showing components in an exemplary optoelectronic transceiver and/or module in accordance with embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it will be readily apparent to one skilled in the art that the present invention may be practiced without these specific details. In other instances, well-known methods, procedures, components and circuits have not been described in detail so as not to unnecessarily obscure aspects of the disclosure.

Some portions of the detailed descriptions which follow are presented in terms of processes, procedures, logic, functions and other symbolic representations of operations on signals, code, data bits or data streams within a computer, transceiver, processor, controller and/or memory. These descriptions and representations are generally used by those skilled in the data processing arts to effectively convey the substance of their work to others skilled in the art. A process, procedure, logic operation, function, process, etc., is herein, and is generally, considered to be a step or a self-consistent sequence of steps or instructions leading to a desired and/or expected result. The steps generally include physical manipulations of physical quantities. Usually, though not necessarily, these quantities take the form of electrical, magnetic, optical, or quantum signals capable of being stored, transferred, combined, compared, and/or otherwise manipulated in a computer, data processing system, optical component, or circuit. It has proven convenient at times, principally for reasons of common usage, to refer to these signals as bits, streams, values, elements, symbols, characters, terms, numbers, information or the like. It should be borne in mind, however, that all of these and similar terms are associated with the appropriate physical quantities and/or signals, and are merely convenient labels applied to these quantities and/or signals.

Unless specifically stated otherwise, or as will be apparent from the following discussions, it is appreciated that throughout the present application, discussions utilizing terms such as “processing,” “operating,” “calculating,” “determining,” or the like, refer to the action and processes of a computer, data processing system, or similar processing device (e.g., an electrical, optical, or quantum computing or processing device or circuit) that manipulates and transforms data represented as physical (e.g., electronic) quantities. The terms refer to actions and processes of the processing devices that manipulate or transform physical quantities within the component(s) of a circuit, system or architecture (e.g., registers, memories, other such information storage, transmission or display devices, etc.) into other data or information similarly represented as physical quantities within other components of the same or a different system or architecture.

Furthermore, in the context of this application, the terms “signal” and “optical signal” refer to any known structure, construction, arrangement, technique, method and/or process for physically transferring data or information from one point to another. The term “wavelength” may refer to a center wavelength of light in a wavelength band, which may be relatively narrow and which generally does not overlap significantly with light having a different wavelength (i.e., a center wavelength in a different wavelength band). Also, unless indicated otherwise from the context of its use herein, the terms “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use. Similarly, for convenience and simplicity, the terms “time,” “rate,” “period” and “frequency” are, in general, interchangeable and may be used interchangeably herein, as are the terms “data,” “bits,” and “information,” but these terms are generally given their art-recognized meanings.

For the sake of convenience and simplicity, the terms “optical” and “optoelectronic” are generally used interchangeably herein, and use of either of these terms also includes the other, unless the context clearly indicates otherwise, but these terms are generally given their art-recognized meanings herein. Furthermore, the term “transceiver” refers to a device having at least one receiver and at least one transmitter, and use of the term “transceiver” also includes the individual terms “receiver” and/or “transmitter,” unless the context clearly indicates otherwise. Also, for convenience and simplicity, the terms “connected to,” “coupled with,” “communicating with,” “coupled to,” and grammatical variations thereof (which terms also refer to direct and/or indirect relationships between the connected, coupled and/or communicating elements unless the context of the term's use unambiguously indicates otherwise) may be used interchangeably, but these terms are also generally given their art-recognized meanings.

Various embodiments and/or examples disclosed herein may be combined with other embodiments and/or examples, as long as such a combination is not explicitly disclosed herein as being unfavorable, undesirable or disadvantageous. The invention, in its various aspects, will be explained in greater detail below with regard to exemplary embodiments.

### An Exemplary Optical Transceiver Module

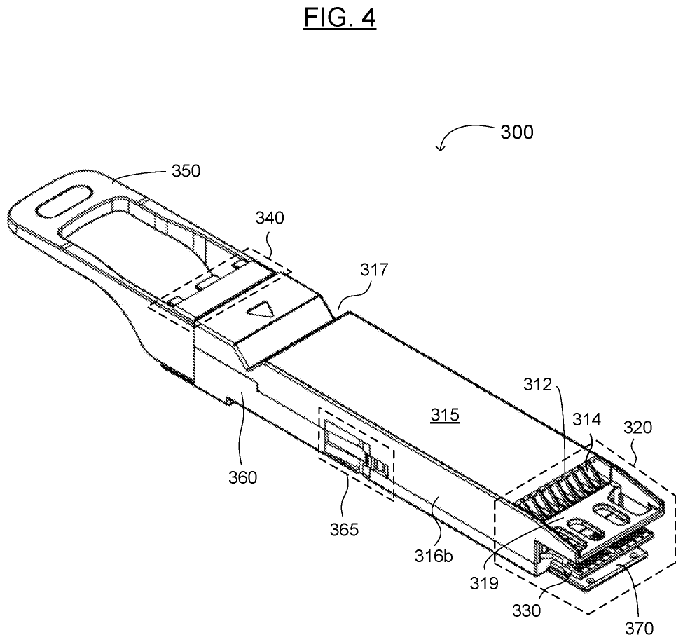

FIG. 3A shows an exemplary optical transceiver module 300 that includes a heat sink top 315, heat sink fins 312, spaces or airflow channels 314 between adjacent fins 312, shell sidewalls 316a-b, a protective circuit board cover 319, an electrical interface 320, an electrical circuit board 330, an optical interface 340, and a handle 350. The exemplary optical transceiver module 300 in FIG. 3A complies with small form factor pluggable (SFP) module packaging requirements, and can be any SFP-compliant module, such as quad small form factor pluggable (QSFP), octal small form factor pluggable (OSFP), or OSFP extra Dense (OSFP-XD). The optical transceiver in the optical transceiver module 300 may transmit and/or receive optical data at rates of from 1-1600 GB/see, or any rate or range of rates therein, although the invention is not limited thereto.

FIG. 3B shows a cross-section of the optical transceiver module 300 along the line B-B′, which includes the heat sink top 315, the heat dissipation fins 312, spaces or airflow channels 314 between adjacent fins 312, a shell body 310, the electrical circuit board 330, one or more integrated circuits 335, a base 360, and a lower protective electrical circuit board cover 370. The heat dissipation fins 312 include or consist essentially of a metal or metal alloy such as zinc, a zinc alloy (e.g., with up to 30% aluminum, up to 5% copper and/or up to 1% magnesium), copper, brass, bronze, aluminum, an aluminum alloy (e.g., with up to ˜ 5% copper and/or up to ˜ 13% silicon), titanium, iron, steel, nichrome, etc., and are integral with the shell body 310. The shell body 310 may also include or consist essentially of the same or a different metal or metal alloy.

The spaces or airflow channels 314 may have a cross-section in the plane of FIG. 3B that is rectangular, square, oval, rectangular or square with rounded corners, trapezoidal or trapezoidal with rounded corners, etc., although the invention is not limited to these shapes. However, rounding the corners of the spaces or airflow channels 314 may facilitate air flow in the channels 314, as eddies can form in sharp corners that impede unhindered air flow through the channels. In some embodiments, outermost ones of the spaces or airflow channels 314 may have an outermost fin 312 on one (vertical) side and a shell top sidewall 313 on an opposite (vertical) side. Alternatively, one or both of the outermost spaces or airflow channels 314 may have a shell sidewall 316 on an opposite (vertical) side from the outermost fin 312.

Conversely, the fins 312 may have a cross-section in the plane of FIG. 3B that is rectangular, rectangular with flared uppermost and/or lowermost sections, trapezoidal or trapezoidal with flared uppermost and/or lowermost sections, etc., but the invention is not limited to such shapes. The cross-sectional shape of the fins 312 is generally complementary to the cross-sectional shape of the adjacent spaces or airflow channels 314. However, in an alternative embodiment, the fins 312 may be discontinuous, and may comprise rows or series of heat sink columns, which may have a cylindrical, parallelepiped or cuboid shape, and which are integral with the shell body 310 and in contact with the shell top 315.

There may be from 1 to 15 fins 312 between the shell top 315 and the shell body 310, or any number or range of numbers between 1 and 15 (e.g., 2-12, 4-10, etc.). Thus, the spacing between adjacent fins 312 when there are 2 or more fins 312 may be from about 1 mm to about 10 mm, or any value or range of values therein (e.g., 1.3-4.0 mm, 1.5-2.5 mm, etc.). In addition, the fins 312 may have a height (from the lowermost point in the adjacent airflow channels 314) of from 2 to 10 mm, or any value or range of values therein (e.g., 3.0-8.0 mm, 3.5-6.0 mm, etc.).

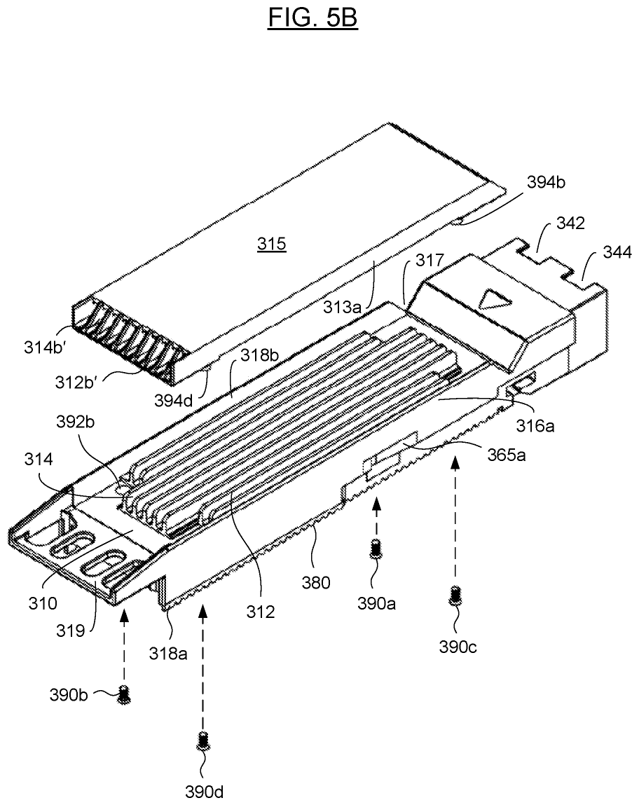

The integrated circuit(s) 335 typically act as heat sources, and introduce heat into or transfer heat to the shell body 310 through one or more conventional thermally conductive interface materials (not shown), such as a solder (e.g., an alloy or mixture of tin with up to 2% copper, up to 5% silver or nickel, up to 1% antimony and/or up to 80% bismuth or gold, including conventional Sn₄₂Bi₅₈) or a thermal gel or thermal paste (e.g., a thermally conductive gel or paste, preferably having adhesive properties, such as a polymer/polymerizable gel of a silicone, an epoxy, a urethane, an acrylate, or a conventional hot-melt adhesive, containing up to 80% by weight of a filler selected from boron nitride, zinc oxide, aluminum nitride and aluminum oxide [wherein the amounts or proportions of polymer and filler=100%], and which may further include one or more organic [e.g., hydrocarbon] solvents). Air may pass or flow through the spaces 314 between the fins 312 along the direction of the length L of the optical transceiver module 300, taking away as much of the heat transferred to the fins 312 and the shell top 315 as possible. The contact area of the shell top 315 with the fins 312 can be bonded (i.e., secured with a thermally conductive adhesive, such as solder or a metal filament-containing epoxy) or not, in which case the shell top 315 may have a slight bend or curve to the interior to ensure contact between the shell top 315 and the fins 312. The shell top 315 and the shell body 310 may be mechanically fixed with screws or bolts (FIG. 5) and/or other fastening mechanisms as described herein to increase reliability, simplify implementation, and reduce costs.

Integral with the shell body 310 are the shell sidewalls 316a-b, the upper electrical circuit board cover 319, and tabs 318a-b. Each of the shell sidewalls 316a-b and the tabs 318a-b have vertically planar major surfaces with a long axis that runs along the length L of the optical transceiver module 300 (FIG. 3A). The upper electrical circuit board cover 319 is generally integral with the shell body 310, and may include one or more openings therein, which may facilitate air flow over (and thus cooling of) the electrical circuit board 330.

The shell top 315 includes integral sidewalls 313a-b that are have vertically planar major surfaces with a long axis that runs along the length L of the optical transceiver module 300, similar to the shell sidewalls 316a-b and the tabs 318a-b. However, in some embodiments, the sidewalls 313a-b may extend slightly outwards from the plane perpendicular to (i.e., away from the center of) the shell top 315. In such embodiments, the shell sidewalls 316a-b may function as a kind of fitting for the shell top sidewalls 313a-b, and the compression between the shell sidewalls 316a-b and the sidewalls 313a-b of the shell top 315 may be sufficient to hold the shell top 315 in place. Alternatively or additionally, the sidewalls 313a-b may be secured or affixed to the shell sidewalls 316a-b with an adhesive (e.g., a thermally conductive adhesive, for example having a thermal conductivity of at least 10, 25, or 40 W/m·K).

The tabs 318a-b of the shell body 310 fit into complementary slots in the base 360. The base 360 includes integral base sidewalls 362a-b that may also be somewhat complementary to the tabs 318a-b. In some embodiments, at least one of (i) the tabs 318a-b and (ii) the base sidewalls 362a-b is configured to compressively hold the other in place. Alternatively or additionally, the tabs 318a-b may be secured or affixed to the base sidewalls 362a-b with an adhesive (e.g., an epoxy or other curable adhesive).

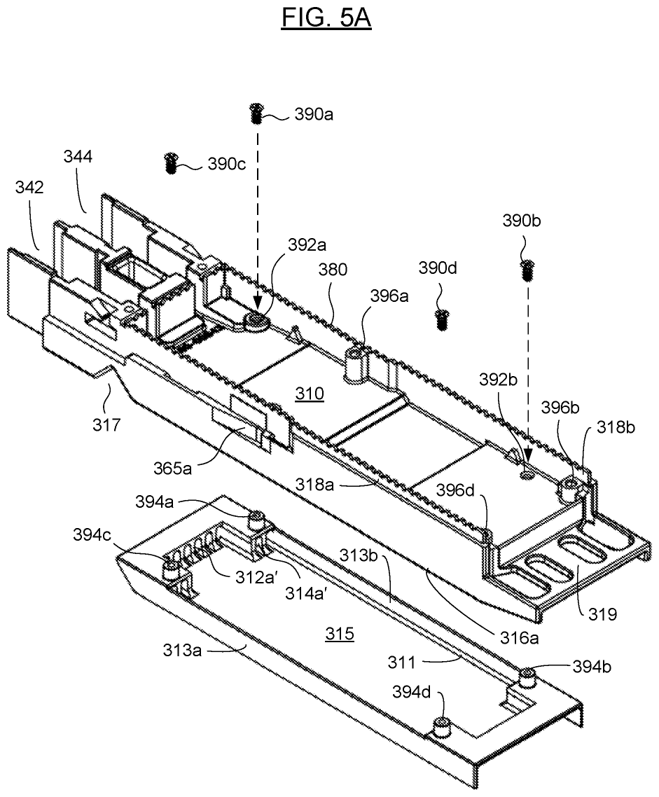

FIG. 4 shows a perspective view of the exemplary optical module 300 of FIGS. 3A-B. The perspective view shows a latch or latch mechanism 365 and a notch 317 in the module packaging, in addition to the shell top 315, the heat sink fins 312, the spaces or airflow channels 314 between adjacent ones of the fins 312, a shell sidewall 316b, the upper electrical circuit board cover 319, the electrical interface 320 including the electrical circuit board 330, the optical interface 340, the handle 350, the base 360 and the lower electrical circuit board cover 370. The opening 355 between the handle 350 and the optical interface 340 is more clearly visible in FIG. 4, as compared to FIG. 3A. The latch/latch mechanism 365 in FIG. 4 is conventional, and will not be described in detail herein, but is just one example of many different implementations of latches and latch mechanisms for optical transceiver modules. The electrical circuit board cover 370 may be integral with and/or an extension of the lowermost surface of the base 360.

The notch 317 is open at the end of the shell top or cover 315, similarly or identically to the visible end of the shell top 315 (i.e., at the electrical interface 320), allowing air flow through the airflow channels 314 between adjacent fins 312. Air flow may be provided by one or more fans in the host device (not shown) into which the electrical interface 320 is inserted. The air flowing in the host device may pass through one or more openings in a socket of the host device, configured to receive the end of the optical module 300 containing the electrical interface 320, then into the spaces 314 between adjacent fins 312 or between an outermost fin 312 and a shell sidewall 316a or 316b, passing along the find 312 below the shell top or cover 315, and exiting through the open face of the notch 317 adjacent to the shell top or cover 315. The angle between the planar uppermost surface of the shell top 315 and the plane of the notch 317 adjoining the uppermost surface of the shell top 315 is generally from 30° to 60° (e.g., 45°), although the invention is not so limited.

An Exemplary Method of Making and/or Assembling an Optical Transceiver Module

An example implementation for a method of assembling the heat sink in the present optical module is shown in FIGS. 5A-B, which are exploded views of the shell body 310 and the heat sink top 315 prior to assembly. In FIG. 5A, the shell body 310 and the heat sink top 315 are shown from the bottom (e.g., upside down relative to the views in FIGS. 3A-4), and FIG. 5B shows the same components from the top, but in a mirror image relative to the view in FIG. 4. The shell body 310 includes parts of optical coupler sockets 342 and 344 in the optical interface 340 (FIGS. 3A and 4), tabs 318a (shown) and 318b (not shown), at least part of the notch 317, an uppermost part 365a of one latch or latch mechanism 365, an electromagnetic interference (EMI) filter 380, and fastener pass-through holes 392a-b. Referring to FIG. 5A, the shell body 310 also includes two additional fastener pass-through holes (not shown) adjacent to the opposite sidewall. The EMI filter 380 is integral with the shell body 310, and in part is integral with and/or an extension from the tabs 318a-b. As shown in FIGS. 5A-B, the EMI filter 380 has a sawtooth pattern, but other patterns (e.g., semicircular or other cycloid, inverted cycloid, sinusoidal, etc.) are also effective.

To assemble the present heat sink, pass the narrow end of the fasteners 390a-d through the corresponding pass-through holes 392 and into receiving holes 394a-d in the shell top 315, then secure the fasteners 390a-d to the shell top 315. For example, the fasteners 390a-d may comprise screws, bolt-and-nut fasteners, or other spirally-threaded fasteners, but the invention is not limited to such fasteners. Similarly, the receiving holes 394a-d may comprise pass-through holes or threaded (e.g., nut-like) bolt receivers integrated with or affixed to the shell top 315, but the invention is not limited thereto. As shown in FIG. 5A, the fasteners 390a-d are screws or bolts, and the receiving holes 394a-d comprise internally spiral-grooved cylinders or truncated cones, in which the spiral grooves in the cylinders or truncated cones 394a-d are complementary to the threads on the screws or bolts 392a-d. Similar receiving holes 396a-d are on the lower internal surface of the shell body 310, for receiving fasteners (not shown) that secure the electrical circuit board 330 (FIGS. 3A-4) to the shell body 310.

Referring now to FIG. 5B, the shell body 310 includes a plurality of integral fins 312, two or more outermost ones of which may be shorter than the others. Such a design may provide space for the pass-through holes 392a-d. The shell top 315 may further include entry fins 312a′ and/or 312b′ at one or more ends thereof (see both FIGS. 5A and 5B) that overlap with and/or effectively extend the heat dissipation fins 312 (not shown in FIG. 5A) on the upper interior surface of the shell body 310, with spaces or airflow channels 314a′ and/or 314b′ between respective adjacent ones of the entry fins 312a′ and 312b′. Entry fins 312a′ and/or 312b′ can also guide the airflow through the space(s) (e.g., spaces 314 and 314a′-b′) between the shell body 310 and the shell top 315. As shown in FIG. 5A, the shell top sidewalls 313a-b may have a curved or beveled corner 311 at the interface with the uppermost surface of the shell top 315.

An Exemplary Optical Transceiver and/or Optical Module

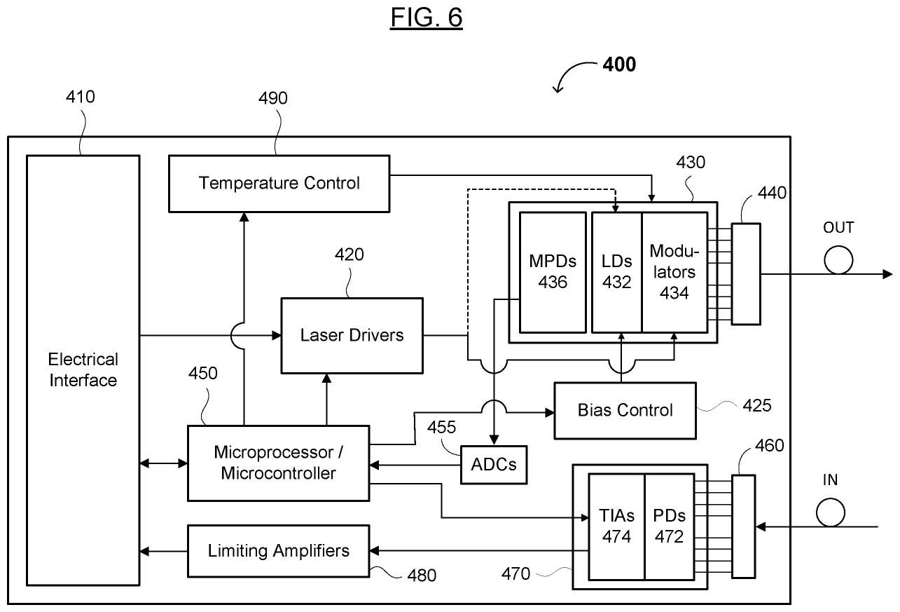

FIG. 6 is a diagram of an exemplary optical transceiver and/or optical module 400 in accordance with embodiments of the present invention that comprises an electrical interface 410, one or more laser drivers 420, a transmitter optical subassembly (TOSA) 430, an optional optical multiplexer 440, a microprocessor or microcontroller (e.g., MCU) 450, an optional optical demultiplexer 460, a receiver optical subassembly (ROSA) 470 and a limiting amplifier 480 coupled in sequence, and a temperature control circuit 490. The TOSA 430 comprises a plurality of laser diodes (LDs) 432, a corresponding plurality of modulators 434 and a corresponding plurality of monitoring photodiodes (MPDs) 436. The ROSA 470 generally includes a plurality of photodiodes (PDs) 472 configured to receive optical signals from a network (e.g., sent over an optical fiber) and convert the optical signals to electrical signals, and optionally, one or more transimpedance amplifiers 474 configured to amplify the electrical signals. The limiting amplifiers 480 are configured to amplify the signals received from the ROSA 470.

In the transmitter path of the optical transceiver and/or module 400, the laser drivers 420 receive electrical data signals from the electrical interface 410 and send data driving signals or pulses to the modulators 434. The electrical interface 410 may receive the data signals from a host device and is conventional. The LDs 432 receive a bias signal or voltage from the bias control circuit 425. Alternatively, the LDs 432 may receive the data driving signals or pulses directly the laser drivers 420, in which case the modulators 434 may not be needed. The MPDs 436 are connected to the MCU 450 via one or more analog-to-digital converter (ADC) circuits or modules 455. Thus, the MCU 450 may receive a digital signal (e.g., a voltage) corresponding to the value of a feedback current from each of the MPDs 436, which may be useful for comparing to one or more thresholds or voltages representative of a target and/or maximum value of the operating range of the laser drivers 420. The MPDs 436, analog-to-digital converters 455, MCU 450 and laser drivers 420 may form a closed-loop automatic power control (APC) regulating loop for maintaining a target optical output power from the LDs 432.

The TOSA 430 (i.e., either the modulators 434 or the LDs 432) outputs a plurality of optical signals, which may have one of two or more polarization types or states, that are combined by the optical multiplexer 440. The multiplexer 440 may include a plurality of lenses, a plurality of filters, one or more mirrors, and optionally, one or more beam combiners and/or one or more optical isolators. As shown in FIG. 6, a multi-channel optical input signal is separated into individual optical signals by the optical demultiplexer 560, which may similarly include a plurality of filters, one or more mirrors, and optionally, one or more beam separators and/or a plurality of lenses.

The PDs 572 receive the individual optical signals and convert them into electrical signals that are amplified by the TIAs 574. The amplified electrical signals output by the TIAs 574 may then be further amplified by the limiting amplifiers 580 prior to transmission by or from the electrical interface 510 (e.g., to the host).

The MCU 550 controls the power of the data signals from the laser drivers 520, the voltage or current of the bias signal provided by the bias control circuit 525, and the gain(s) of the TIAs 574 and/or limiting amplifiers 580. The MCU 550 also controls the temperature control circuit 590, which in turn controls the temperature of the LDs 532 and optionally the modulators 534. Generally, the temperature of the LDs 532 and the modulators 534 may be controlled by regulating the power supplied to them (e.g., when the temperature of the LDs 532 is too high, the bias from the bias control circuit may be reduced, and when the temperature of the LDs 532 is too low, the bias from the bias control circuit may be increased).

### CONCLUSION/SUMMARY

Embodiments of the present invention advantageously provide an optical transceiver module and methods for making and using the optical transceiver module.

The foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A heat sink for an optical or optoelectronic module, comprising:
a shell body comprising a first metal or metal alloy, a plurality of fins integral with the shell body and comprising the first metal or metal alloy, and one or more airflow passages between adjacent ones of the plurality of fins; and
a shell top, in physical and/or thermal contact with the shell body and the plurality of fins, the shell top comprising a second metal or metal alloy and having first and second opposing sidewalls comprising the second metal or metal alloy, wherein:
the first and second opposing sidewalls are configured to secure the shell top to the shell body, and
the plurality of fins are configured to transfer heat to air in the one or more airflow passages and to the shell top.

2. The heat sink of claim 1, further comprising a plurality of fasteners configured to secure the shell top to the shell body.

3. The heat sink of claim 2, wherein each of the plurality of fasteners comprises a bolt or a screw, one of the shell top and the shell body further comprises a corresponding plurality of pass-through holes having dimensions allowing the plurality of fasteners to pass therethrough, and the other of the shell top and the shell body further comprises a corresponding plurality of receiver holes configured to receive the plurality of fasteners.

4. The heat sink of claim 1, further comprising a thermally conductive adhesive between and in contact with both of the shell top and the shell body.

5. The heat sink of claim 1, wherein each of the first metal or metal alloy and the second metal or metal alloy independently comprises zinc, a zinc alloy, copper, brass, bronze, aluminum, an aluminum alloy, iron, steel, titanium or nichrome.

6. The heat sink of claim 1, wherein the plurality of fins comprise 2-12 fins.

7. The heat sink of claim 6, wherein each of the one or more airflow passages has a cross-section that is rectangular, square, oval, rectangular or square with rounded corners, trapezoidal or trapezoidal with rounded corners.

8. The heat sink of claim 6, wherein each of the plurality of fins have a cross-section that is rectangular, rectangular with flared end (e.g., uppermost and/or lowermost) sections, trapezoidal or trapezoidal with flared end sections.

9. The heat sink of claim 6, wherein each of the plurality of fins has a cross-sectional shape that is complementary to a cross-sectional shape of an adjacent one of the one or more airflow passages.

10. The heat sink of claim 1, wherein the shell body further comprises (i) first and second shell body sidewalls on opposing sides of the shell body and (i) first and second tabs on the opposing sides of the shell body, the first and second shell body sidewalls contacting the opposing sidewalls of the shell top, and the tabs being configured to contact or mate with sidewalls of a base of the optical module.

11. An optical or optoelectronic transceiver module, comprising:
a transmitter optical subassembly;
a receiver optical subassembly;
an electrical interface in communication with each of the transmitter optical subassembly and the receiver optical subassembly;
an optical interface in communication with each of the transmitter optical subassembly and the receiver optical subassembly;
a circuit board with at least one integrated circuit thereon, the at least one integrated circuit being in communication with at least one of the transmitter optical subassembly, the receiver optical subassembly, the electrical interface and the optical interface; and
the heat sink of claim 1, in thermal proximity or thermal communication with the at least one integrated circuit.

12. The optical transceiver module of claim 11, wherein the at least one integrated circuit comprises:
a plurality of laser diodes, each configured to receive a driver signal and output a first optical signal;
a plurality of optical modulators corresponding to the plurality of laser diodes, each of the plurality of optical modulators being configured to modulate a corresponding first optical signal; and
a plurality of photodiodes, each configured to receive a second optical signal and output an electrical signal.

13. The optical transceiver module of claim 12, wherein the at least one integrated circuit further comprises:
a plurality of laser drivers corresponding to the plurality of laser diodes, each of the plurality of laser drivers being configured to provide a corresponding driver signal to a corresponding one of the plurality of laser diodes;
a bias control circuit, configured to provide one or more bias control signals to the plurality of laser diodes; and
a plurality of amplifiers, each configured to amplify a unique electrical signal from the plurality of photodiodes.

14. The optical transceiver module of claim 13, wherein the at least one integrated circuit further comprises a microprocessor or a microcontroller, configured to control the plurality of laser diodes, the plurality of optical modulators, the plurality of laser drivers, the bias control circuit, and the plurality of amplifiers.

15. The optical transceiver module of claim 11, further comprising a handle adjacent to the optical interface.

16. A method of making a heat sink for an optical or optoelectronic module, comprising:
forming a shell body comprising a first metal or metal alloy, a plurality of fins integral with the shell body and comprising the first metal or metal alloy, and one or more airflow passages between adjacent ones of the plurality of fins;
forming a shell top comprising a second metal or metal alloy and having first and second opposing sidewalls comprising the second metal or metal alloy; and
fastening the shell top to the shell body.

17. The method of claim 16, wherein the shell top is fastened to the shell body with a plurality of fasteners.

18. The method of claim 17, wherein each of the plurality of fasteners comprises a bolt or a screw, one of the shell top and the shell body further comprises a corresponding plurality of pass-through holes having dimensions allowing the plurality of fasteners to pass therethrough, and the other of the shell top and the shell body further comprises a corresponding plurality of receiver holes configured to receive the plurality of fasteners.

19. The method of claim 16, wherein the shell top is fastened to the shell body with a thermally conductive adhesive between and in contact with both of the shell top and the shell body.

20. A method of operating an optical or optoelectronic transceiver module, comprising:
generating a plurality of first optical signals from a plurality of laser diodes in response to a plurality of driver signals;
generating a plurality of electrical signals from a plurality of photodiodes in response to a plurality of second optical signals; and
dissipating heat from the optical transceiver module using the heat sink of claim 1.
